(19) United States
(12) Patent Application Publication
(10) Pub. No.: US 2010/0096996 A1
(43) Pub. Date: Apr. 22, 2010

(54) LIGHT SOURCE DETECTION AND CONTROL SYSTEM

(75) Inventors: Hsin-Chao Chen, Chiayi City (TW); Yu-Chi Huang, Hsinchu City (TW); Ruei-Ming Gan, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/391,240

(22) Filed: Feb. 23, 2009

(30) Foreign Application Priority Data
Oct. 20, 2008 (TW) 97140164

(51) Int. Cl. H05B 39/04; H05B 37/02

(52) U.S. Cl. 315/154; 315/152

(57) ABSTRACT

A light source detection and control system applied to a backlight module is provided. The system includes a liquid crystal display (LCD) panel, a plurality of light guide panels, a plurality of anisotropic transmission media, a photo detector (PD), and a controller. The LCD panel is divided into multiple blocks, each including white or RGB light sources. The light guide panels are disposed on the blocks for collecting and guiding the light emitted by the light sources. The anisotropic transmission media are connected to the light guide panels for transmitting the light emitted by the light sources. The PD is connected to the anisotropic transmission media for receiving the light and detecting the luminance of the light emitted by the light sources. The controller is coupled to the PD for adjusting the luminance or color shift of the light sources according to the luminance detected by the PD.

### CROSS-REFERENCE TO RELATED APPLICATION

This application claims the priority benefit of Taiwan application serial no. 97140164, filed on Oct. 20, 2008. The entirety of the above-mentioned patent application is hereby incorporated by reference herein and made a part of this specification.

### BACKGROUND OF THE INVENTION

1. Field of the Invention

The present invention generally relates to a light source detection and control system.

2. Description of Related Art

In the consideration of cost, the backlight sources of the current liquid crystal displays (LCDs) are mostly white light emitting diodes (WLEDs). However, aging effect may occur to the common LEDs with the operation time or temperature variation, thus inducing visual color shift (turning to a cool or warm color).

For example, FIG. 1 is a relationship diagram showing the luminance attenuation of conventional WLEDs when heated. Referring to FIG. 1, as the attenuation rate of the red light under heating is high, while the blue light is less susceptible to temperature, once the temperature rises, the red light is attenuated and the blue light is sustained, so that the light emitted by the WLED reflects the cool color and results in the visual color shift. Further, FIG. 2 is a relationship diagram showing the luminance attenuation of conventional WLEDs with the operation time. Referring to FIG. 2, as the green light is more durable, while the blue light will be attenuated after long-time usage, once the service time is prolonged, color shift may occur due to the attenuation of the blue light.

Based on the above factors, the WLED is suitable for small-sized panels like personal digital assistants or cell phones. Accordingly, if the WLED is to be used in large-sized panels, it is necessary to adjust the non-uniform background luminance or color through negative feedback control.

Particularly, in the application of the large-sized panels, feedback mechanisms are generally employed to compensate the attenuated luminance. The luminance of the backlight sources is controlled through the concept of regional control, so as to moderately save the power consumption of the backlight sources and improve the color contrast. For instance, the luminance of the backlight sources in the dark regions of the frame is decreased, while the luminance of the backlight sources in the bright regions of the frame is sustained.

Moreover, FIG. 3 is a cross-section view of a conventional bottom-lighting light guide panel structure and a photo detector (PD) feedback control system. Referring to FIG. 3, in the conventional bottom-lighting light guide panel structure, a frame is generally divided into many blocks, each having a set of bottom-lighting LEDs 310. Through a light guide panel 320, the light emitted by the LEDs 310 is transmitted to a PD 340, and the point light sources are uniformly expanded into a surface light source and emitted through an LCD panel 330.

However, as the light transmission in the light guide panels 320 is isotropic, the distance between the LEDs 310 and the PD 340 may affect the value of the detected light intensity. Therefore, in the industry, a set of PD 340 and controller 350 are disposed on about every 2×2 blocks for regional feedback.

FIG. 4 is a schematic view of a conventional large-sized panel backlight source detection and control system. Referring to FIG. 4, taking a 4×4 region as an example, at least four PDs (PDs 1-4) and five controllers (Controllers 1-5) are needed for backlight control. However, as being limited by the distance between the LEDs and the PDs, the large-sized panel must adopt a tree structure. In such structure, the control of the LEDs is achieved through layers of controllers. When the frame is operated rapidly, image persistence may occur due to hierarchy delay. Further, the PDs disposed on the panel are easily affected by differences in process, voltage, and temperature (PVT).

### SUMMARY OF THE INVENTION

Accordingly, the present invention is directed to a light source detection and control system, for transmitting the light emitted by light sources through anisotropic transmission media to an external PD so as to achieve the feedback control.

A light source detection and control system includes a liquid crystal display (LCD) panel, a plurality of light guide panels, a plurality of anisotropic transmission media, a photo detector (PD), and a controller. The LCD panel is divided into a plurality of blocks, each including a plurality of light sources. The light guide panels are disposed on the blocks for collecting and guiding the light emitted by the light sources of each block. The anisotropic transmission media are connected to the light guide or light source of each block. The PD is connected to the anisotropic transmission media for receiving the light transmitted by the anisotropic transmission media so as to detect a luminance of the light emitted by the light sources of each block. The controller is coupled to the PD for adjusting the luminance of the light sources of each block according to the luminance or color shift detected by the PD.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a relationship diagram showing the luminance attenuation of conventional WLEDs when heated.

FIG. 2 is a relationship diagram showing the luminance attenuation of conventional WLEDs with the operation time.

FIG. 3 is a cross-section view of a conventional bottom-lighting light guide panel structure and a PD feedback control system.

FIG. 4 is a schematic view of a conventional large-sized panel backlight source detection and control system.

FIG. 5 is a schematic view of a light source detection and control system according to an embodiment of the present invention.

FIGS. 6(a) and 6(b) are schematic views of a time division multiplexing detection and control performed on WLEDs according to an embodiment of the present invention.

FIGS. 7(a) and 7(b) are schematic views of a time division multiplexing detection performed on RGB LEDs according to an embodiment of the present invention.

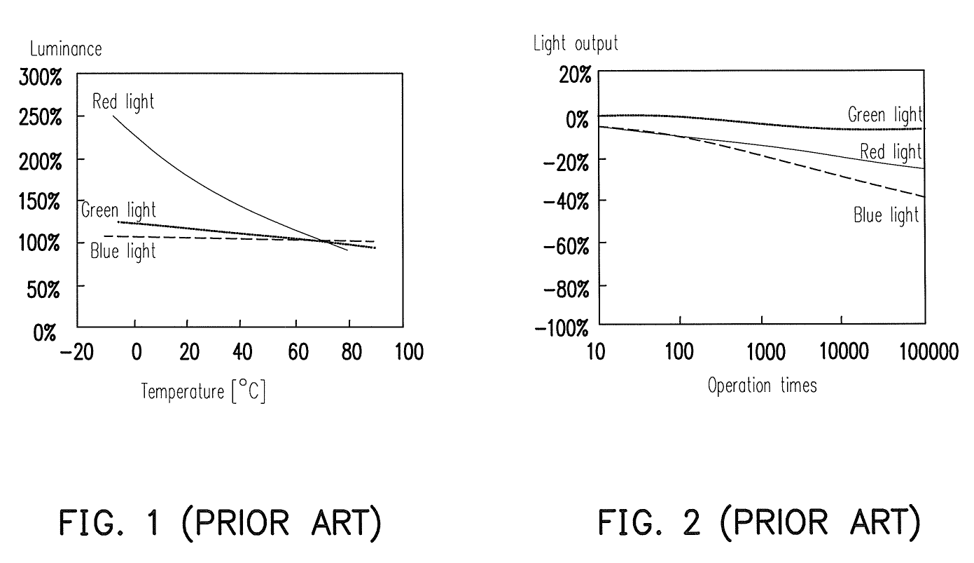

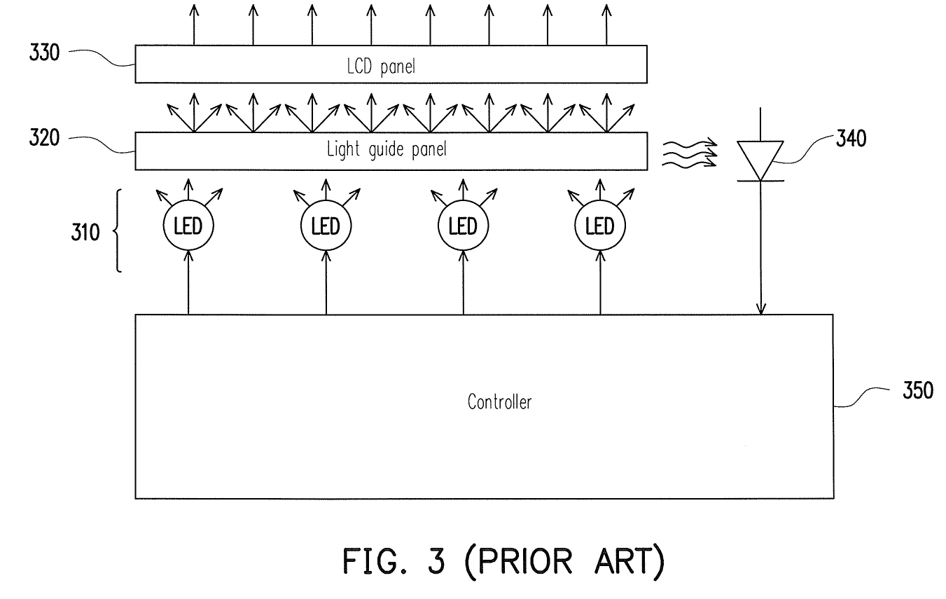

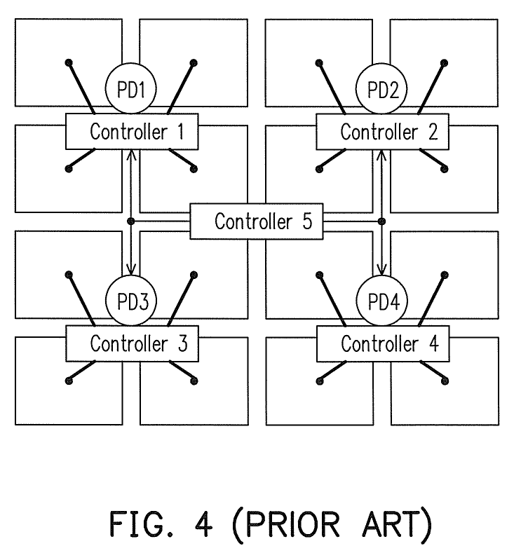

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

According to a new feedback mode in an embodiment of the present invention, the light emitted by the light sources of each block in the LCD panel is transmitted to a photo detector (PD) in a routing manner through anisotropic transmission media such as optical fibers. This structure is applicable to the feedback control of white LEDs (WLEDs) or red, green, and blue (RGB) LEDs. As described above, a light source detection and control system is provided, and in order to make the content of the present invention comprehensible, the following embodiments are particularly given for implementing the invention.

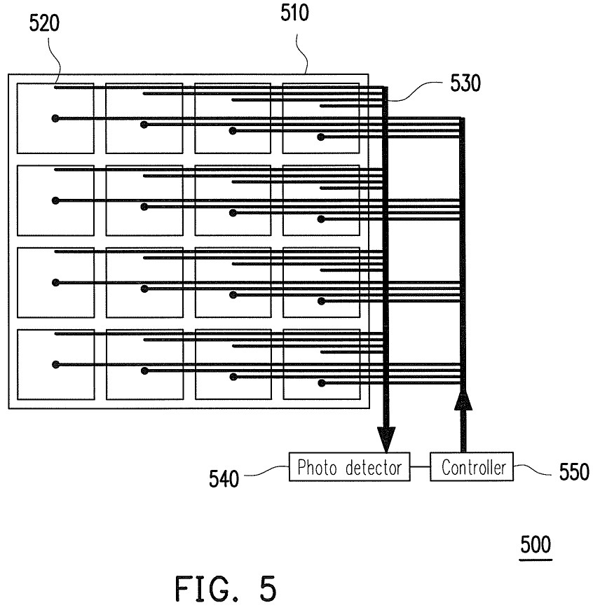

FIG. 5 is a schematic view of a light source detection and control system according to an embodiment of the present invention. Referring to FIG. 5, the light source detection and control system 500 of this embodiment is applicable to a bottom-lighting LCD with an LCD panel of above 24 inches, and includes an LCD panel 510, a plurality of light guide panels 520, a plurality of anisotropic transmission media 530, a PD 540, and a controller 550. The functions of the elements are described hereinafter.

The LCD panel 510 is divided into a plurality of blocks, each including a set of bottom-lighting light sources. The light sources may be white LEDs (WLEDs) or RGB LEDs. The LCD panel 510 is controlled individually according to the blocks, thus achieving the regional luminance control and compensation.

The light guide panels 520 are disposed on the blocks of the LCD panel 510 for collecting and guiding the light emitted by the light sources in addition to uniformly expanding the light of the point light sources into a surface light source.

The anisotropic transmission media 530 are, for example, made of an optical fiber with a working wavelength range covering the wavelength range of the light emitted by the light sources or other low-loss and low-dispersion optical materials, capable of providing low-loss performance during short-distance transmissions, and convenient for circuit design due to their characteristics in having a small volume and being flexible. Thereby, the impact of the anisotropic transmission media 530 on the luminance of the light sources is reduced to the minimum.

The PD 540 is connected to output ends of the anisotropic transmission media 530 for receiving the light and detecting the luminance of the light emitted by the light sources of each block. The type of the PD 540 depends on the type of the light sources adopted by the LCD panel 510. For example, if the LCD panel 510 adopts WLEDs, a photo sensor is required, and if the LCD panel 510 adopts RGB LEDs, red, green, and blue PDs are required respectively.

It should be noted that, the PD 540 has an electrode capable of receiving light. The electrode is not directly connected to the external anisotropic transmission media 530, and instead, the light is directly transmitted to the electrode through the anisotropic transmission media 530 from a certain distance, so as to be detected by the electrode. As a single PD 540 is employed to receive the light transmitted by the anisotropic transmission media 530, in order to avoid the generation of difference due to different positions of the anisotropic transmission media 530, when the PD 540 is connected to the anisotropic transmission media 530, it is necessary to make the distance between the output end of each of the anisotropic transmission media 530 and the electrode be the same.

The controller 550 is coupled to the PD 540 for correspondingly adjusting the luminance of the light sources of each block according to the luminance detected by the PD 540. For example, when the luminance of a certain block is low, the controller 550 may adjust the luminance of the light sources thereof to be higher, and when the luminance of a certain block is sufficiently high, the luminance of the light sources thereof will be sustained.

By means of the above structure, the feedback control of the light sources can be realized by a single PD. When the controller adjusts the luminance of the light sources of each block, a time division multiplexing manner is adopted for sequentially turning on the light sources of each block and respectively detecting the luminance of the blocks, so as to adjust the luminance of the light sources. For different types of light sources, the time division multiplexing manner can be divided into time division multiplexing for WLEDs or time division multiplexing for RGB LEDs, and the details will be illustrated below by embodiments.

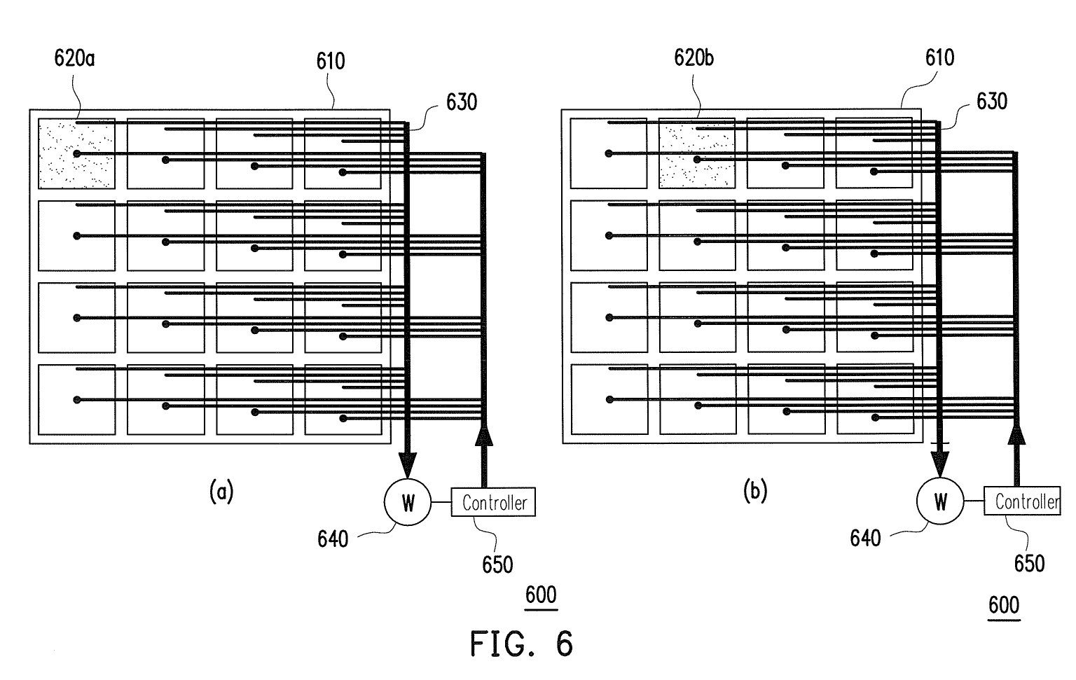

FIGS. 6(a) and 6(b) are schematic views of a time division multiplexing detection and control performed on WLEDs according to an embodiment of the present invention. First, referring to FIG. 6(a), the structure of a light source detection and control system 600 of this embodiment is the same as that of the previous embodiment, in which the light sources are WLEDs, and the PD is a white PD 640.

When performing the feedback control, the light source detection and control system 600 adopts the time division multiplexing manner. In each detection clock, merely LEDs of one block are turned on, and the light is transmitted to the white PD 640 for detection through an optical fiber. Referring to FIG. 6(a), the light source detection and control system 600 starts from a block 620a, and the luminance detection and feedback control are performed on each block in sequence. When the feedback control of the block 620a is completed, the feedback control of a block 620b is then performed (as shown in FIG. 6(b)). After all the blocks of the whole LCD panel have been detected, the detection is returned to the blocks 620a, thus achieving the light source detection and control by a single PD. The impact of differences in process, voltage, and temperature (PVT) can be avoided by employing the same PD, such that the large-sized panel becomes more uniform.

It should be noted that, human eyes are insensitive to the flicker above 120 Hz. Therefore, as for an LCD panel of 8×8 blocks, it is enough to control the frequency of the time division multiplexing of the controller at 8 kHz (approximately equal to 8×8×120).

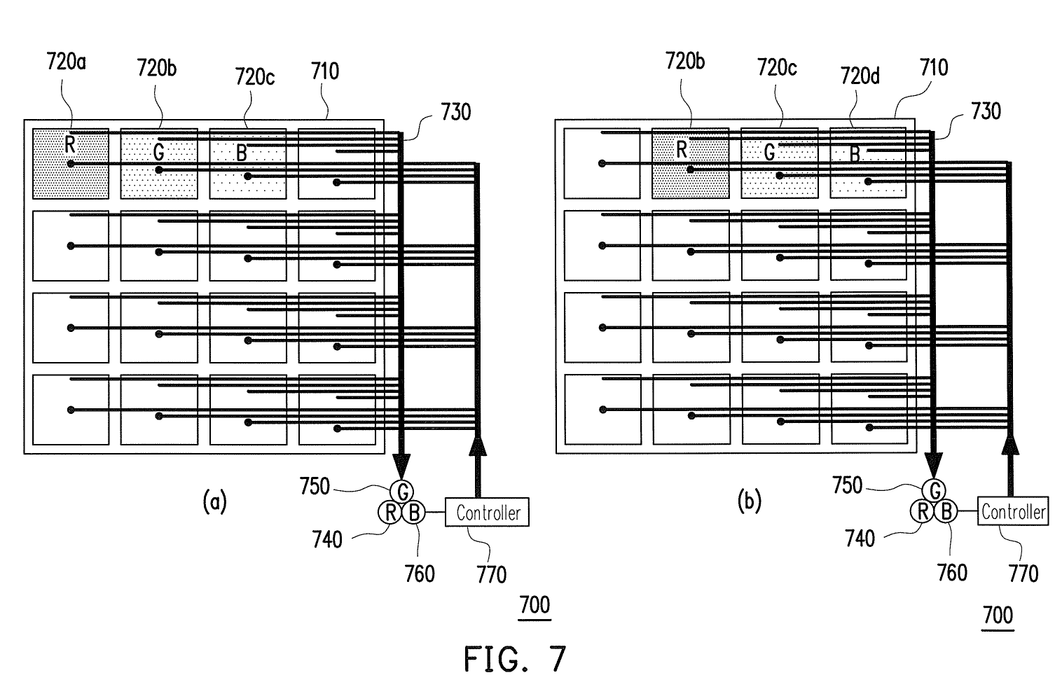

Further, FIGS. 7(a) and 7(b) are schematic views of a time division multiplexing detection performed on RGB LEDs according to an embodiment of the present invention. First, referring to FIG. 7(a), the structure of a light source detection and control system 700 of this embodiment adopts RGB LEDs as the light sources, and the PD includes a red PD 740, a green PD 750, and a blue PD 760.

When performing the feedback control, the light source detection and control system 700 adopts a time division multiplexing manner. In each detection clock, the RGB LEDs of any three blocks are turned on respectively. Referring to FIG. 7(a), the light source detection and control system 700 takes any three blocks (for example, blocks 720a, 720b, and 720c) as a group, and performs detection and feedback control on the light emitted by the RGB LEDs. When the feedback control of the three blocks is completed, the detection and feedback control is shifted rightward by one block to detect the light emitted by the RGB LEDs in the blocks 720b, 720c, 720d (as shown in FIG. 6(b)). In this manner, the detection and feedback control are repeated to realize the detection and control of the color light sources through the three PDs.

In view of the above, the light source detection and control system of the present invention adopts anisotropic transmission media for transmission by means of time division multiplexing feedback control, so as to realize the luminance compensation of the large-sized panel and maintain the uniformity of the color. By replacing the conventional controllers, PD, or color sensor with the structure of a single PD and a controller, the response in regional control becomes more rapid so as to reduce the image persistence.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light source detection and control system, comprising:
a liquid crystal display (LCD) panel, divided into a plurality of blocks, each block comprising a plurality of light sources;
a plurality of light guide panels, disposed on the blocks, for collecting and guiding the light emitted by the light sources of each block;
a plurality of anisotropic transmission media, connected to the light guide panels, for transmitting the light emitted by the light sources of each block;
a photo detector (PD), connected to the anisotropic transmission media, for receiving the light transmitted by the anisotropic transmission media, so as to detect a luminance of the light emitted by the light sources of each block; and
a controller, coupled to the PD, for adjusting the luminance of the light sources of each block according to the detected luminance.

2. The light source detection and control system according to claim 1, wherein the LCD panel is applicable to a bottom-lighting LCD.

3. The light source detection and control system according to claim 1, wherein the light sources comprise white light emitting diodes (WLEDs), and the PD comprises a photo sensor.

4. The light source detection and control system according to claim 3, wherein the controller turns on the light sources of the blocks and detects the luminance of the blocks by means of time division multiplexing so as to adjust the luminance of the light sources.

5. The light source detection and control system according to claim 1, wherein the light sources comprise red, green, and blue (RGB) LEDs, and the PD comprises a red PD, a green PD, and a blue PD.

6. The light source detection and control system according to claim 5, wherein the controller turns on the light sources of any three of the blocks and detects the luminance of the blocks by means of time division multiplexing so as to adjust the luminance of the light sources, and the turned-on light sources of the three blocks comprise red LEDs of a block, green LEDs of a block, and blue LEDs of a block.

7. The light source detection and control system according to claim 1, wherein adopt the anisotropic transmission media such like optical fiber with a working wavelength range covering the wavelength range of the light emitted by the light source.

8. The light source detection and control system according to claim 1, wherein the PD comprises an electrode, and the distances between output ends of the anisotropic transmission media and the electrode are the same.
